(19) United States
(12) Patent Application Publication
(10) Pub. No.: US 2020/0062915 A1
(43) Pub. Date: Feb. 27, 2020

(54) METHOD AND FORMULATION FOR RENEWABLE POLYETHYLENE FOAMS

(71) Applicant: Sealed Air Corporation (US), Charlotte, NC (US)

(72) Inventors: Natarajan Ramesh, Waxhaw, NC (US); Chee Yap, Oxford, CT (US); Lewis Smith, Arlington, TX (US)

(21) Appl. No.: 16/495,448

(22) PCT Filed: Jan. 8, 2018
(86) PCT No.: PCT/US2018/012771

§ 371 Date: Sep. 19, 2019

Related U.S. Application Data
(60) Provisional application No. 62/474,680, filed on Mar. 22, 2017.

(51) Int. Cl. C08J 9/00; C08J 9/14; C08J 9/06; C08F 10/02; C08L 23/06; B32B 5/32

(52) U.S. Cl. CPC C08J 9/0061; B32B 2266/025; C08J 9/141; C08J 9/06; C08F 10/02; C08L 23/06; B32B 5/32; C08J 2203/184; C08J 2203/10; C08J 2203/14; C08J 2201/03; C08J 2323/06; C08J 2423/06; C08L 2207/066; C08L 2205/025; B32B 2250/22; C08J 9/0023

(57) ABSTRACT

A method of making a foam using a renewable resource and a foam thereof is disclosed. The foam is made using green polyethylene polymers made from renewable sugarcane ethanol. The use of these polymers to make foam has the potential to reduce carbon dioxide gas emissions by more than half. The foam can be used in a variety of applications and can also be made with blends of renewable LDPE and non-renewable LDPE.

### BACKGROUND OF THE INVENTION

The present invention is in the technical field of foams. More particularly, the present invention is in the technical field of foams made from renewable materials.

Conventional foams are made from polyolefins, and the polyolefins are often petroleum-based polyolefins. With changing global trends facing the foam industry, due to environmental concerns on greenhouse gas emissions and high dependency on depleting petroleum-based resources, it is critical to focus on advancement of a strong sustainability strategy for creating a better way for life. Starch and PLA foam have been developed as a renewable foam. However, it has been shown that increasing starch levels in starch-based foams reduces physical and mechanical properties, such as density, expansion ratio, compressibility, flexibility, and elasticity. PLA has a relatively low glass transition temperature (about 111-145° F.) which causes PLA foam to soften and deform in hot temperatures or during transport during the summer. PLA is also more brittle than a petroleum-based plastic, such as acrylonitrile butadiene styrene. Therefore, these foams have undesirable properties as they are not as flexible and are brittle when compared to standard petroleum-based foams. There is a need for a foam made from renewable materials, but is also flexible, less brittle, and has improved moisture resistance while providing cushioning benefits.

Currently, there are green polyethylene polymers made from renewable sugarcane ethanol. The use of these polymers to make foam has the potential to reduce carbon dioxide gas emissions by more than half when compared to petroleum-based foams. The development of foam made from LDPE that is from renewable bio-derived feed stocks such as sugarcane will play a vital role in re-imagining the industry by bringing more sustainable benefits to end users.

### SUMMARY OF THE INVENTION

The present invention is directed to a method of making a foam. The method may include creating a blend of a polyolefin made from sugarcane ethanol with a minimum biocontent of 94% as determined by ASTM D6866-16, less than 3% of a nucleating agent, and 0.2% to 2% of an aging modifier. The blend may further include a petroleum-based polyolefin to the above ingredients. The method may include mixing a physical blowing agent with the previously mentioned blend to form a mixture. The method may include expanding the mixture to make a foam. The foam may have 20-99% biocontent as determined by ASTM D6866-16. The foam may have a density of 1 to 12 pounds per cubic foot (lb/ft³).

The invention is also directed to a foam. The foam may have a polyolefin made from sugarcane ethanol with a minimum biocontent of 94% as determined by ASTM D6866-16, less than 3% of a nucleating agent, and 0.2% to 2% of an aging modifier. The foam may also include a petroleum-based polyolefin. The foam may also include less than 0.5% isobutane. The foam may have 20-99% biocontent as determined by ASTM D6866-16. The foam may have a density of 1 to 12 lb/ft³.

In some embodiments, the foam may be a foam laminate. The foam laminate may have a first foam layer and a second foam layer adhered to the first foam layer. The foam may also have additional foam layers. The foam may have 20-99% biocontent as determined by ASTM D6866-16. The foam may have a density of 1 to 12 lb/ft³.

### BRIEF DESCRIPTION OF THE DRAWING

FIG. 1 is a schematic diagram of a foaming process;

FIG. 2 is a picture of the average cell size of an embodiment of the foam at 0.25 inches thick and a density of 2.27 lb/ft³ at 15× magnification.

FIG. 3 is a picture of the average cell size of an embodiment of the foam at 0.5 inches thick and a density of 1.52 lb/ft³ at 7× magnification.

FIG. 4 is a picture of the average cell size of an embodiment of the foam at 1 inch thick and a density of 1.37 lb/ft³ at 7× magnification.

FIG. 5 is a graph showing the drop height transmitted shock cushioning performance at 12 inches of an embodiment of the invention;

FIG. 6 is a graph showing the drop height transmitted shock cushioning performance at 24 inches of an embodiment of the invention;

FIG. 7 is a graph showing the drop height transmitted shock cushioning performance at 30 inches of an embodiment of the invention.

FIG. 8 is a graph showing the drop height transmitted shock cushioning performance at 36 inches of an embodiment of the invention.

### DETAILED DESCRIPTION OF THE INVENTION

The invention discloses the development of a renewable polyethylene foam on a commercial scale extrusion system at commercially viable output rates for the first time. The method of making the foam is very beneficial in generating a wide range of foam thicknesses, densities and widths for easy fabrication. The newly developed foam can be used for cushioning, damage reduction, and cube optimization through efficient packaging design. Some common foam applications include electronics packaging, sports and leisure, construction, and transportation.

While the following terms are believed to be well understood by one of ordinary skill in the art, the following definitions are set forth to facilitate explanation of the presently disclosed subject matter. Unless defined otherwise, all technical and scientific terms used herein have the same meaning as commonly understood to one of ordinary skill in the art to which the presently disclosed subject matter belongs.

Following long standing patent law convention, the terms “a”, “an”, and “the” refer to “one or more” when used in the subject application, including the claims. Thus, for example, reference to “a formulation” includes a plurality of such formulations, and so forth.

Unless indicated otherwise, all numbers expressing quantities of components, reaction conditions, and so forth used in the specification and claims are to be understood as being modified in all instances by the term “about.” Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, percentage, and the like can encompass variations of, and in some embodiments, ±20%, in some embodiments ±10%, in some embodiments ±5%, in some embodiments ±1%, in some embodiments ±0.5%, and in some embodiments ±0.1%, ±0.01%, from the specified amount, as such variations are appropriated in the disclosed package and methods.

As used herein, the term “additive” refers to any substance, chemical, compound or formulation that is added to an initial substance, chemical, compound or formulation in a smaller amount than the initial substance, chemical, compound or formulation to provide additional properties or to change the properties of the initial substance, chemical, compound or formulation.

As used herein, the term “bio-based” refers to a product that is composed, in whole or in significant part, of biological products or renewable domestic agricultural materials, forestry materials or an intermediate feedstock. Examples of renewable domestic agricultural materials include plants, animals, and marine materials.

As used herein, the term “recyclable” refers to the ability of the components of a material (e.g. foam, foam laminate, foam sheets, foam planks, foam rods) to enter into current recycling streams established for petroleum-based resins (e.g. LDPE, HDPE, PET, PP) or paper without compromising the suitability of recycled resin or paper output for use in remaking components. As used herein, the term “recycled” refers to a material (e.g. foam, foam laminate, foam sheets, foam planks, foam rods, polyolefins, resins) that has been treated or processed so that it can be reused.

As used herein, the term “renewable” refers to the ability of any resource or material (e.g. resins such as polyethylene resins) to be readily replaced and of non-fossil origin, specifically not of petroleum origin. An example of a renewable material would be a polyolefin derived from plants, such as sugarcane. A non-renewable resource is available in limited supply and does not renew in a sufficient amount of time. An example of a non-renewable material would be petroleum-based polyolefins.

All formulation percentages used herein are presented on a “by weight” basis, unless designated otherwise.

Although the majority of the above definitions are substantially as understood by those of skill in the art, one or more of the above definitions can be defined herein above in a manner differing from the meaning as ordinarily understood by those of skill in the art, due to the particular description herein of the presently disclosed subject matter.

The foam may include a polyolefin. The polyolefin may be a polyethylene. The polyethylene may be high density polyethylene (HDPE), low density polyethylene (LDPE), linear low density polyethylene (LLDPE) or very low density polyethylene (VLDPE). In some embodiments, the polyolefin may be LDPE. The LDPE may be made from a renewable resource. The renewable resource may be sugarcane ethanol. In some embodiments, the polyethylene may be any one of the green polyethylenes available from Braskem. The green polyethylenes from Braskem are a renewable polyethylene alternative to conventional, petroleum-based polyethylenes and can be recycled in the same chains already developed for conventional polyethylenes. All of Braskem's green polyethylenes are produced from sugarcane ethanol.

In some embodiments, the polyolefin may be any LDPE that is made from renewable resources (renewable polyolefin). The renewable resources may be bio-based. The polyolefin may be made from sugarcane ethanol with a minimum biocontent of 90% as determined by ASTM D6866-16. In other embodiments, the polyolefin would be made from a sugarcane ethanol with a minimum biocontent of 94% as determined by ASTM D6866-16. In further embodiments, the polyolefin would be made from a sugarcane ethanol with a minimum biocontent of 96% as determined by ASTM D6866-16. Non-limiting examples of the polyolefin may include Braskem SLD4004, Braskem SPB208, Braskem SPB608, Braskem SEB853, Braskem STN7006, Braskem SBF0323HC, Braskem SBF0323HC/12HC, Braskem STS7006, Braskem SEB853/72, Braskem SPB681, Braskem SPB681/59, Braskem SBC818, or combinations thereof. In some embodiments, the polyolefin may be Braskem SLD4004. The physical properties for these Braskem polyolefins are listed in Table 1 below. The renewable polyolefin may be virgin, recycled, or a mixture of virgin and recycled renewable polyolefin. Recycled renewable polyolefins may also be referred to as reprocessed renewable polyolefins.

TABLE 1

| Braskem | | | | | Deflection | |
|---|---|---|---|---|---|---|
| Green | Melt Flow | | Tensile | Vicat | Temperature | Minimum |
| Polyolefin | Rate | | Strength | Softening | under load | C14 |
| (LDPE) | (190° C./2.16 kg) | Density | at Yield | Temperature | (0.455 Mpa) | Content |
| ASTM | D1238 | D792 | D638 | D1525 | D648 | D6866-16 |
| Method | | | | | | |
| Units | g/10 min | g/cm³ | MPa | ° C. | ° C. | % |
| SLD4004 | 2.00 | 0.923 | — | — | — | 96 |
| SPB208 | 22.0 | 0.923 | 10 | 87 | 43 | 95 |
| SPB608 | 30.0 | 0.915 | 8 | 79 | 42 | 95 |
| SEB853 | 2.7 | 0.923 | — | — | — | 95 |
| STN7006 | 0.6 | 0.924 | — | — | — | 95 |
| SBF0323HC | 0.32 | 0.923 | — | — | — | 95 |
| Braskem | | | | | | |
| Green | Melt Flow | | | | | Minimum |
| Polyolefin | Rate | | | | | C14 |
| (LDPE) | (190° C./2.16 kg) | Density | Thickness | Gloss | Additives | Content |
| ASTM | D1238 | D1505/D792 | — | D2457 | — | D6866-16 |
| Method | | | | | | |
| Units | g/10 min | g/cm³ | μμ | — | — | % |
| SBF0323HC/ | 0.32 | 0.923 | 70 | 80 | antiblocking | 95 |
| 12HC | | | | | agent and | |
| | | | | | slip agent | |
| STN7006 | 0.6 | 0.924 | 40 | 90 | — | 95 |
| STS7006 | 0.6 | 0.925 | 40 | 80 | antiblocking | 95 |
| | | | | | agent and | |
| | | | | | slip agent | |
| SEB853/72 | 2.7 | 0.923 | 40 | — | antiblocking | 95 |
| | | | | | agent and | |
| | | | | | slip agent | |
| SPB681 | 3.8 | 0.922 | 40 | 75 | — | 95 |
| SPB681/59 | 3.8 | 0.922 | 40 | — | antiblocking | 95 |
| | | | | | agent and | |
| | | | | | slip agent | |
| SBC818 | 8.3 | 0.918 | 25 | 76 | — | 95 |

The foam may also include a petroleum-based polyolefin. The petroleum-based polyolefin may be made from non-renewable resources (non-renewable polyolefin). Petroleum-based polyolefins may include polymers such as low density polyethylene (LDPE), linear low density polyethylene (LLDPE), high density polyethylene (HDPE), very low density polyethylene (VLDPE), ultra low density polyethylene (ULDPE), medium density polyethylene (MDPE), metallocene-catalyzed polyethylenes (mPE), ethylene alpha olefins, ultra high molecular weight polyethylenes (UHMWPE), EVA copolymers, polypropylene (PP) homopolymer, PP copolymers, high melt strength polypropylenes (HMS PP), irradiated linear polyolefins, and combinations thereof. The irradiated linear polyolefins may be used to enhance melt strength. The petroleum-based polyolefin may be any other plastomers, elastomers and polyolefin polymers known to one of skill in the art. The petroleum-based polyolefins may be virgin, recycled, or a mixture of virgin and recycled petroleum-based polyolefins. Recycled petroleum-based polyolefins may also be referred to as reprocessed petroleum-based polyolefins. A recycled petroleum-based polyolefin may be recycled LDPE. A virgin petroleum-based polyolefin may be virgin LDPE.

The polyolefin may be a blend of polyolefins from renewable resources and non-renewable resources. By blending the nonrenewable polyolefin with a renewable polyolefin, the biocontent of the foam can be reduced. In some embodiments, the polyolefin may be a blend of a polyolefin made from sugarcane ethanol and a petroleum-based polyolefin. For example, the polyolefin may be LDPE with a minimum based biocontent of 94% as determined by ASTM D6866-16 and a petroleum-based LDPE. The petroleum-based LDPE may have a density range of 0.917 g/cm³ to 0.919 g/cm³, a melt index range (190° C./2.16 kg) of 2.0 g/10 min to 2.6 g/10 min, and a melt flow ratio (21.6 kg/2.16 kg) of 46 to 60. The petroleum-based LDPE may have a density range of 0.914 to 0.928 g/cm³. In some embodiments, the polyolefin may be Braskem SLD4004 and a petroleum-based LDPE with a density of 0.9176 g/cm³, a melt index (190° C./2.16 kg) of 2.29 g/10 min, and a melt flow ratio (21.6 kg/2.16 kg) of 50.5.

The foam may have greater than 75% of a polyolefin. The foam may have 96%-99% of a polyolefin. The foam may have 96% to 99% of a polyolefin made from sugarcane ethanol. The foam may have 75%, 80%, 85%, 88%, 90%, 91%, 92%, 93%, 94%, 95%, 96%, 97%, 98%, 98.2%, 98.4%, 98.5%, 98.6%, 98.73%, 98.8%, 99% of a polyolefin or any range between any of these values. In some embodiments, the foam may have 98.73% of a polyolefin made from sugarcane ethanol. In other embodiments, the foam may have 98.4% of a polyolefin made from sugarcane ethanol. In other embodiments, the foam may have 98.5% of a polyolefin made from sugarcane ethanol. The foam may have greater than 75% of a blend of a polyolefin made from sugarcane ethanol and a petroleum-based polyolefin. In some embodiments, the foam may have a polyolefin that is a blend of 98.4% polyolefin made from sugarcane ethanol and 1.6% petroleum-based polyolefin. In some embodiments, the foam may have a polyolefin that is a blend of 20%-98.4% polyolefin made from sugarcane ethanol and 1.6% to 80% petroleum-based polyolefin. The foam may be referred to as a hybrid foam or a hybrid blend foam when it comprises both a renewable polyolefin and a non-renewable polyolefin.

The non-renewable polyolefin may have 0-100% virgin petroleum-based polyolefin (e.g. LDPE). The non-renewable polyolefin may have 0-100% recycled petroleum based polyolefin. The non-renewable polyolefin may have a combination of both virgin and recycled petroleum-based polyolefins at any ratio. The renewable polyolefin may be either virgin or recycled. Any other combinations of multiple polyolefins or their blends is possible to derive a wide range of properties. The non-renewable polyolefin may have 0%, 2%, 4%, 6%, 8%, 10%, 15%, 20%, 25%, 30%, 35%, 40%, 45%, 50%, 55%, 60%, 65%, 70%, 75%, 80%, 85%, 90%, 95%, 100% virgin petroleum-based polyolefin. The non-renewable polyolefin may have 0%, 2%, 4%, 6%, 8%, 10%, 15%, 20%, 25%, 30%, 35%, 40%, 45%, 50%, 55%, 60%, 65%, 70%, 75%, 80%, 85%, 90%, 95%, 100% recycled petroleum-based polyolefin.

The foam may have a nucleating agent. The nucleating agent may be silica, talc, zinc oxide, zirconium oxide, clay, mica, titanium oxide, calcium silicate, metallic salts of fatty acids such as zinc stearate, self-nucleating agents such as carbon dioxide, nitrogen or other gases, and chemical foaming agents. Self-nucleating agents can generate or enhance the nucleation of bubbles when they are used alone or when combined with other nucleating agents. In some embodiments, the nucleating agent may be a talc mixture. Talc as a powder does not incorporate well into polyolefin. A masterbatch may be prepared of the talc with 50% talc particles in LDPE resin, resulting in a talc mixture. The nucleating agent may be a chemical foaming agent. These chemical foaming agents can decompose and generate gases during the method of making a foam. The chemical foaming agent may be one of Clariant's Hydrocerol® chemical foaming agents.

The foam may have less than 3% of a nucleating agent. The foam may have 3%, 2%, 1.5%, 1%, 0.75%, 0.7%, 0.66%, 0.65%, 0.55%, 0.5%, 0.4%, 0.3%, 0.28%, 0.25%, 0.2%, 0.1% of a nucleating agent or any range between any of these values. In some embodiments, the foam may have 0.28% of a nucleating agent. In other embodiments, the foam may have 0.5% of a nucleating agent. In further embodiments, the foam may have 0.66% of a nucleating agent.

The foam may have an aging modifier. The aging modifier may be a fatty acid amide, a fatty acid ester, glycerol monostearate, a hydroxyl amide, or combinations thereof. In some embodiments, the aging modifier may be glycerol monostearate.

The foam may have 0.2% to 2% of an aging modifier. The foam may have 2%, 1.5%, 1%, 0.99%, 0.98%, 0.9%, 0.88%, 0.85%, 0.8%, 0.5%, 0.4%, 0.3%, 0.2%, 0.1%, of an aging modifier or any range between any of these values. In some embodiments, the foam may have 0.98% of an aging modifier. In other embodiments, the foam may have 0.99% of an aging modifier. In further embodiments, the foam may have 1% of an aging modifier.

The foam may have a physical blowing agent. The physical blowing agent is added during the method of making a foam. The physical blowing agent dissolves in the polyolefin and disperses out of the foam after the foam has been prepared. There is a gas-air exchange in the foam, which has the physical blowing agent being replaced by air. In some embodiments, the physical blowing agent will not completely disperse out of the foam. This may result in a negligible amount of the physical blowing agent to be present in the foam. In some embodiments, this amount may be less than 0.01%. In other embodiments, the amount of physical blowing agent may be less than 0.003% present in the foam.

The physical blowing agent may be air, argon, boron tetrafluoride, boron trichloride, normal 20-butane, carbon dioxide, helium, hexafluoride, hydrocarbons such as ethane, hexane, isobutane, nitrogen, nitrogen tetrafluoride, nitrous oxide, pentane, propane, silicon tetrafluoride, sulfur hexafluoride, water, xenon, or combinations thereof. In some embodiments, the physical blowing agent may be isobutane. The isobutane can be blended with other hydrocarbons. In some embodiments, the physical blowing agent may be non-flammable carbon dioxide. The carbon dioxide may be used alone or it may be blended with hydrocarbons. In other embodiments, the carbon dioxide may be added to the isobutane. In further embodiments, the additional hydrocarbons may be added to the mixture of isobutane and carbon dioxide. The additional hydrocarbons may be a blend of C2-C6 hydrocarbons. The blend may be butane, propane and pentane. In other embodiments, the blend may be normal butane, isobutane, propane and pentane.

The method of making the foam may include adding less than 15% by weight of solids in the foam (solids may include polyolefin, nucleating agent, colorant and aging modifier) of a physical blowing agent. In some embodiments, the solids of the foam may not include a colorant. The method of making the foam may include adding 14% by weight of solids in the foam, 13% by weight of solids in the foam, 12.16% by weight of solids in the foam, 12.14% by weight of solids in the foam, 12.07% by weight of solids in the foam, 12% by weight of solids in the foam, 11.81% by weight of solids in the foam, 11.8% by weight of solids in the foam, 11% by weight of solids in the foam, 10.6% by weight of solids in the foam, 10.56% by weight of solids in the foam, 10% by weight of solids in the foam, 9% by weight of solids in the foam, 8% by weight of solids in the foam, 7% by weight of solids in the foam, 6% by weight of solids in the foam, 5% by weight of solids in the foam, 4% by weight of solids in the foam, 3% by weight of solids in the foam, 2% by weight of solids in the foam, 1% by weight of solids in the foam of a physical blowing agent or any range between any of these values. In some embodiments, the method of making the foam may include adding 12.16% by weight of solids in the foam of a physical blowing agent. In other embodiments, the method of making the foam may include adding 12.14% by weight of solids in the foam of a physical blowing agent. In further embodiments, the method of making the foam may include adding 12.07% by weight of solids in the foam of a physical blowing agent. In yet further embodiments, the method of making the foam may include adding 11.8% by weight of solids in the foam of a physical blowing agent. In some embodiments, the method of making the foam may include adding 11.81% by weight of solids in the foam of a physical blowing agent.

The foam may have an additive. The additive may be pigments, colorants, fillers, stability control agents, antioxidants, flame retardants, stabilizers, fragrances, odor masking agents, antistatic agents, lubricants, foaming aids, coloring agents, deterioration inhibitors, or combinations thereof. In some embodiments, the additive may be a colorant.

The foam may have less than 2% of an additive. In some embodiments, the foam may include 0.005%, 0.007%, 0.008%, 0.01%, 0.05%, 0.075%, 0.1%, 0.2%, 0.25%, 0.26%, 0.29%, 0.3%, 0.4%, 0.5%, 0.75%, 1.0%, 1.2%, 1.4%, 1.44%, 1.75%, 1.8%, 1.82%, 1.83%, 2.0%, 3.0%, 4.0%, 4.5%, 4.6%, 4.62%, 5.0%, 5.25%, 5.3%, 5.32%, 5.5%, 6%, 7%, 10% of an additive or any range between any of these values. In some embodiments, the foam may have 0.26% of an additive. In other embodiments, the foam may have 0.3% of an additive.

### Methods of Making the Foam

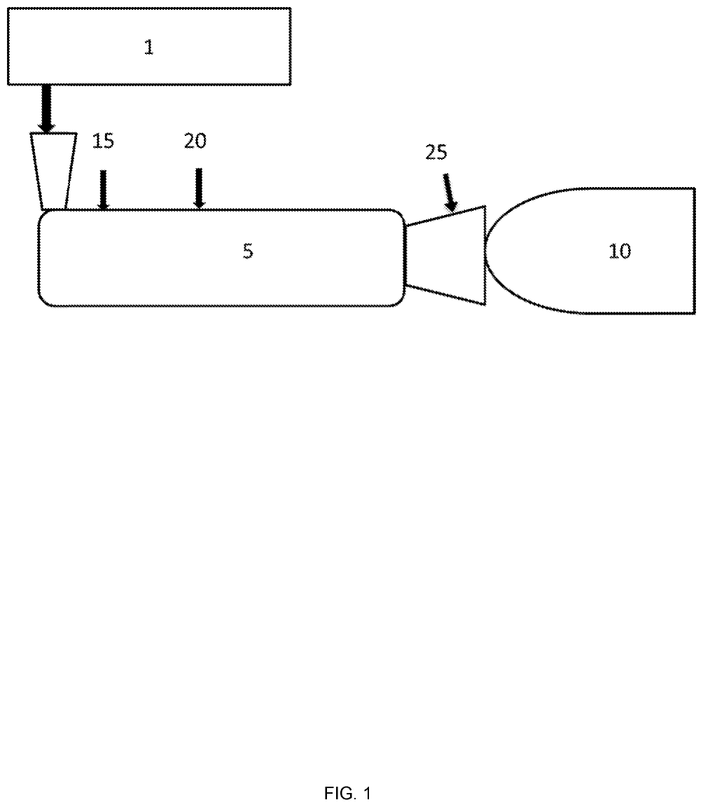

The present invention is directed to a method of making a foam. FIG. 1 represents an embodiment of a method of making the foam. The polyolefin and the nucleating agent may be fed into a first hopper 1 at a first location as a blend. In some embodiments, a petroleum-based polyolefin may be fed into the first hopper 1 at a first location as part of the blend of polyolefin and nucleating agent. In other embodiments, the blend may also include an aging modifier. The blend may then be fed into an extruder 5. The aging modifier may be added to the extruder 5 in a second hopper at a second location 15, separated from the blend in the first hopper 1 at a first location. The aging modifier may be glycerol monostearate and may be melted and pumped into the extruder at a second location 15 or a microcellular molding process after the polyolefin and the nucleating agent are melted to result in a more homogeneous mixture. In some embodiments, the method of making a foam may include creating a blend of a polyolefin made from sugarcane ethanol with a minimum biocontent of 94% as determined by ASTM D6866-16, less than 3% of a nucleating agent, and 0.2% to 2% of an aging modifier. The blend may have 96% to 99% of the polyolefin. In other embodiments, the method of making a foam may include creating a blend of a polyolefin made from sugarcane ethanol with a minimum biocontent of 94% as determined by ASTM D6866-16, a petroleum-based polyolefin, less than 3% of a nucleating agent, and 0.2% to 2% of an aging modifier. The blend may further include an additive. In some embodiments, the additive may be a colorant, an anti-stat, or both.

The method may include adding a physical blowing agent to the extruder 5 in a third hopper at a third location 20 downstream. Adding the physical blowing agent downstream allows for the physical blowing agent to be thoroughly mixed by the action of the counter-rotating screws of the twin screw extruder. In some embodiments, the physical blowing agent may be added in the first hopper 1 or the second hopper at a second location 15, or the third hopper at a third location 20. In some embodiments, the method of making a foam may further include mixing the physical blowing agent with the blend of polyolefin, nucleating agent, and aging modifier to form a mixture. In some embodiments, the mixture may have 96% to 99% of the polyolefin made from sugarcane ethanol with a minimum biocontent of 94% as determined by ASTM D6866-16. In other embodiments, the mixture may have a blend of the polyolefin made from sugarcane ethanol with a minimum biocontent of 94% as determined by ASTM D6866-16 and the petroleum-based polyolefin.

The foam may be extruded by using a single screw extrusion system or a tandem extrusion system where there is a primary extruder (twin or single screw) and a larger secondary extruder (traditionally single screw) connected in sequence to enhance cooling efficiency. In some embodiments, the foam may be extruded using a twin-screw extruder. In other embodiments, a tandem extrusion system may be used. When a tandem extrusion system is used, the nucleating agent may be Hydrocerol®.

Once the mixture is well mixed, it is cooled gradually closer to the melt temperature before entering into a die 25. The die 25 may be an annular die, a circular die, a flat die, or a strand die. In some embodiments, the die 25 may be an annular die. Inside the annular die, the mixture is distributed evenly at higher pressure than atmosphere. When the polymer flows through the die lips and exits the die 25 there is a sudden pressure drop so the thermodynamic unstability causes nucleation of tiny bubbles. Once they nucleate the cells grow and thus the polymeric foam expands. The method may include expanding the mixture to make a foam. The step of expanding the foam may occur after the mixture exits the die 25. After foam expansion the foam may be taken over a cooling mandrel or other mechanical systems before slitting at the bottom to convert its cylindrical form 10 to a flat sheet form.

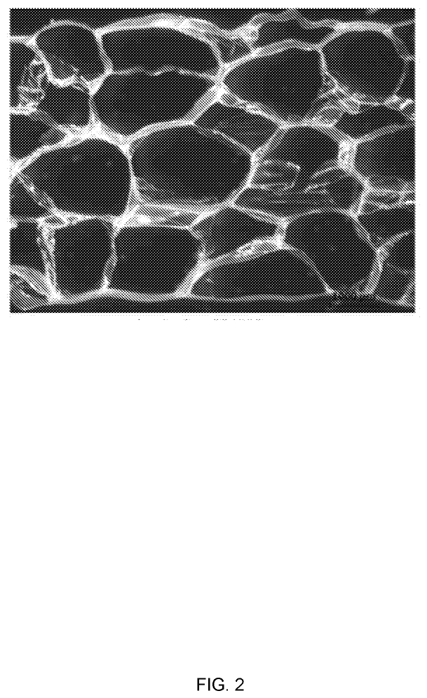

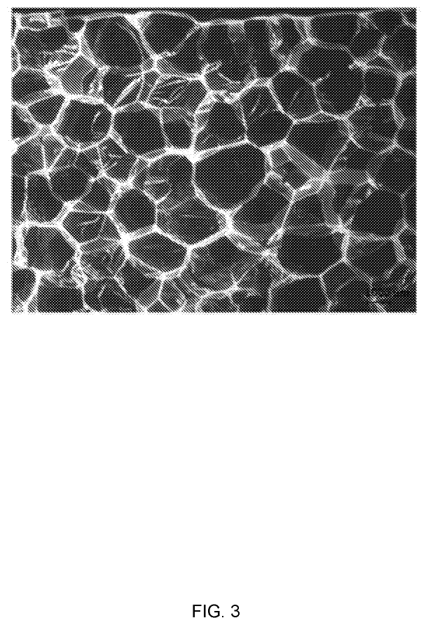

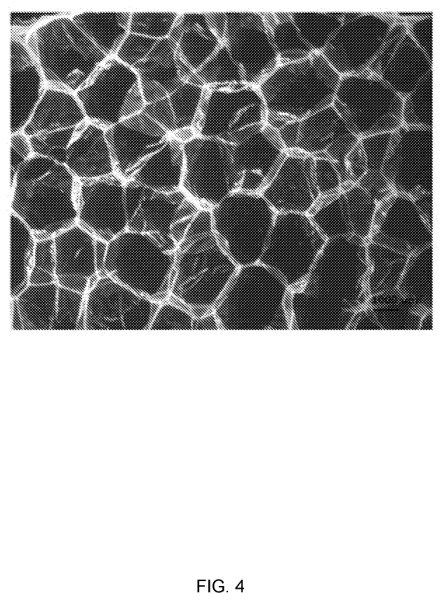

When using a flat die, a homogeneous plank of foam can be made during the step of expanding the mixture. This homogeneous plank may have a thickness greater than 25 mm. Once the expansion is complete, the polyolefin or polyolefins will have polymerized and will be cured along with the additional ingredients to make a foam. The foam may be a solidified matrix surrounding or encasing a cellular structure of a plurality of cells. FIGS. 2-4 are pictures of embodiments of the cell structure of the foam at various thickness and density amounts. FIG. 2 is the cell structure of an embodiment of the foam at 0.25 inches thick with a density of 2.27 lb/ft³ at 15× magnification. The approximate mean cell size of a 30 cell count was about 1.5 mm with a standard deviation of 0.9 mm in the horizontal direction. FIG. 3 is the cell structure of an embodiment of the foam at 0.5 inches thick with a density of 1.52 lb/ft³ at 7× magnification. The approximate mean cell size of a 30 cell count was about 1.74 mm with a standard deviation of 1.03 mm in the horizontal direction. FIG. 4 is the cell structure of an embodiment of the foam at 1 inch thick with a density of 1.37 lb/ft³ at 7× magnification. The approximate mean cell size of a 30 cell count was about 1.71 mm with a standard deviation of 1.01 mm in the horizontal direction. However, the cell size in the vertical and thickness directions were found to be smaller in FIGS. 2-4 than the cell size mentioned in the horizontal direction.

The foam may have carbon dioxide. The gas air exchange once the foam has been made results in carbon dioxide being present in the foam. Depending on the rate of gas air exchange, the amount of carbon dioxide can vary. The residual carbon dioxide from the blowing agent left in the foam after the gas air exchange may be less than 0.1% by weight. In some embodiments, the carbon dioxide present in the foam may be less than 0.05%. Another result of the gas air exchange, results in a decreased amount of the physical blowing agent in the foam. The foam may have less than 0.5% isobutane. In some embodiments, the physical blowing agent may be isobutane and the foam may have less than 0.5% isobutane. In other embodiments, the physical blowing agent may be isobutane and the foam may have less than 0.01% isobutane. The isobutane may be residual isobutane. The residual isobutane may be left from the curing process of the foam.

The foam may be made using a bead molding process. A bead molding process requires several steps that may include obtaining pellets that contain impregnated blowing agent, pre-expansion of pellets into beads, expanded beads aging, molding of expanded beads using steam for shaping and bonding together to form a desired part and cooling and releasing. This process is popular in making EPS (Expanded polystyrene), EPE (expanded polyethylene) and EPP (expanded polypropylene) molded foams.

The foam may be made using a microcellular molding process. Microcellular foams are typically foams with a cell size below 100 microns. These foams are made by using a batch process or semi-continuous process. For a batch process, the mother board is saturated with various gases such as nitrogen or carbon dioxide at high pressure in an autoclave or pressure chamber at higher temperature. Once the gas diffuses and saturates the polymer, the mold may be cooled or kept at certain temperature for foaming and the depressurization occurs rapidly. When the mold opens the plastic expands up to 50 times expansion in all directions due to sudden pressure drop. Microcellular foams resulting from this process have fine cellular structure and good low abrasion properties with great aesthetics. The foam may be made from any method described above.

### Foam

The foam may be produced from the methods described above. The foam may be a regular foam, a microcellular foam or a nanocellular foam.

The foam may have a thickness of 0.5 mm to 100 mm. The foam may have a thickness of 0.5 mm, 0.75 mm, 1 mm, 5 mm, 6.35 mm, 10 mm, 12.7 mm, 15 mm, 20 mm, 25 mm, 25.4 mm, 30 mm, 40 mm, 50 mm, 60 mm, 70 mm, 80 mm, 90 mm, 100 mm, or any range between any of these values. The foam may have a thickness of 6.35 mm (0.25 inches). The foam may have a thickness of 12.7 mm (0.5 inches). The foam may have a thickness of 25.4 mm (1 inch).

The foam may be a sheet, a plank, a homogeneous plank, or a rod. In some embodiments, the foam may be a foam sheet. The foam sheet may have a thickness of 0.5 mm to 300 mm. In other embodiments, the foam may be a homogeneous plank. The homogeneous plank may have a thickness of 30 mm to 100 mm. The foam may be multiple sheets that are laminated together. In some embodiments, the foam may be a foam laminate. The foam laminate may have a thickness greater than 30 mm. In some embodiments, the foam laminate may have a thickness of 40 mm to 200 mm. In some embodiments, the foam may have a cell size of 50 microns to 3 mm. In some embodiments, the foam may have a cell size of 1.7 mm. In other embodiments, the foam may have a cell size of 1.5 mm. In further embodiments, the foam may have a cell size of 1.0 mm. The foam may be used for any one or more of void fill, blocking or bracing, thermal insulation, cushioning, package cushioning, sound insulation or vibration dampening.

The foam may have 20-99% biocontent as determined by ASTM D6866-16. In some embodiments, the foam may have 50-99% biocontent as determined by ASTM D6866-16. In other embodiments, the foam may have greater than 98% biocontent as determined by ASTM D6866-16. In some embodiments, the foam may have 99% biocontent as determined by ASTM D6866-16. The addition of petroleum-based polyolefin will decrease the biocontent of the foam. When using only the polyolefin made from sugarcane ethanol, the biocontent may be 94% or greater.

The foam may have a density of 1 to 12 pounds per cubic foot (lb/ft³). The foam may have a density of 1 lb/ft³, 1.37 lb/ft³, 1.48 lb/ft³, 1.52 lb/ft³, 2 lb/ft³, 2.27 lb/ft³, 2.37 lb/ft³, 3 lb/ft³, 4 lb/ft³, 5 lb/ft³, 6 lb/ft³, 7 lb/ft³, 8 lb/ft³, 9 lb/ft³, 10 lb/ft³, 11 lb/ft³, 12 lb/ft³, or any range between any of these values. In some embodiments, the density of the foam may be 1.37 lb/ft³. In other embodiments, the density of the foam may be 1.48 lb/ft³. In further embodiments, the density of the foam may be 1.52 lb/ft³. In yet further embodiments, the density of the foam may be 2.37 lb/ft³.

The foam may have a compressive strength at 25% strain of less than 15 psi for a density of about 1.38 lb/ft³. In some embodiments, the foam may have a compressive strength of at least any of the following: 6 psi, 7 psi, 8 psi, 8.1 psi, 9 psi, 10 psi, 11 psi, 12 psi, 13 psi, 14 psi, 14.5 psi, or any range between these values. The foam may have a compressive strength of 6 to 11 psi at 25% strain for a density of about 1.38 lb/ft³. The compression strength will increase with increase in density.

The foam may have a compressive strength at 50% strain of less than 25 psi for a density of about 1.38 lb/ft³. In some embodiments, the foam may have a compressive strength of at least any of the following: 6 psi, 8 psi, 10 psi, 12 psi, 14 psi, 16 psi, 17 psi, 17.2 psi, 18 psi, 20 psi, 22 psi, 24 psi, 24.5 psi, or any range between these values. The foam may have a compressive strength of 12 to 22 psi at 50% strain for a density of about 1.38 lb/ft³. The compression strength will increase with increase in density.

The foam may have a polyolefin made from sugarcane ethanol with a minimum biocontent of 94% as determined by ASTM D6866-16, less than 3% of a nucleating agent, 0.2% to 2% of an aging modifier, and have 10% to 99% biocontent as determined by ASTM D6866-16 and have a density of 1 to 12 pounds per cubic foot. The foam may have 25% of a renewable polyolefin that is LDPE and 74.5% of a petroleum-based polyolefin that is recycled LDPE. The foam may have a ratio of renewable LDPE to non-renewable petroleum based LDPE of 10:90, 15:85, 20:80, 25:75, 30:70, 35:65, 40:60, 45:55, 50:50, 55:45, 60:40, 65:35, 70:30, 75:25, 80:20, 85:15, 90:10, or any range between these ratios.

In some embodiments, a foam laminate may be made from the foam. The foam laminate may have a first foam layer and a second foam layer. The second foam layer may be adhered to the first foam layer. In some embodiments, the foam laminate may have additional foam layers. The first foam layer and the second foam layer may have 10% to 99% biocontent as determined by ASTM D6866-16 and have a density of 1 to 12 pounds per cubic foot. Hot-air lamination equipment may be used to laminate 2 foam sheets from roll stock material into foam laminate that are planks. Two rolls of foam with a 1″ sheet thickness may be taken and hot air may be injected between the 2 layers of foam sheets and then passed through rollers to apply pressure to bond those foam sheets. The hot air melts the polymer sufficiently to bond well across entire thickness of the foam. This bond may offer strength at the interface. The laminated 2″ thick foam laminate in plank form emerges from the other side. The foam laminate may be trimmed on the edges and cut at the ends to generate a 2″ thick×48″ wide×108″ long foam laminate as planks for commercial use. The same lamination process may be used with more sheets to produce planks of 3″, 4″ and 6″ thickness depending on commercial applications.

The foam laminate may have a thickness greater than 30 mm. The foam laminate may have a thickness of 40 mm to 200 mm. The foam laminate may have a compressive strength of 6 to 11 psi at 25% strain for 1.37 lb/ft3 foam density. In some embodiments, the foam laminate may have a compressive strength at 25% strain of 8.1 psi. The foam laminate may have a compressive strength of 12 to 22 psi at 50% strain for 1.37 lb/ft3 foam density. In some embodiments, the foam laminate may have a compressive strength at 50% strain of 17.2 psi for 1.37 lb/ft3 foam density. The compression strength will increase with increase in density.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

### EXAMPLES

### Example 1: Bio-Based Carbon Testing of Samples 1 and 2

In order to measure the % bio-based carbon content, ASTM D6866-16 test was conducted at Beta Analytic, Inc at Miami, Fla. (ISO/IEC 17025:2005 Accredited). ASTM D6866-16 cites the definition of bio-based as containing organic carbon of renewable origin like agricultural, plant, animal, fungi, microorganisms, marine, or forestry materials living in a natural environment in equilibrium with the atmosphere. Therefore, the percentage bio-based carbon in manufactured products most commonly indicates the amount of non-petroleum derived carbon present. It is calculated and reported as the percentage renewable organic carbon to total organic carbon (TOC) present.

Two methods of analysis are described in ASTM D6866-16—Method B (AMS) and Method C (Liquid Scintillation Counting (LSC). Method B is the most accurate and precise and was used to produce this result. The methods determine % bio-based carbon content using radiocarbon (aka C14, carbon-14, 14C). The C14 signature is obtained relative to modern references. If the signature is the same as CO₂ in the air today, the material is 100% bio-based carbon, indicating all the carbon is from renewable resources and no petroleum-based or other fossil carbon (non-renewable resource) is present. If the signature is zero, the product is 0% bio-based carbon and contains only petrochemical or another fossil carbon. Values between 0% and 100% indicate a mixture of renewable and fossil carbon. The analytical term for the C14 signature is percent modern carbon (pMC) and will typically have a cited error of 0.1-0.4 pMC (1 RSD) using Method B. Percent modern carbon is the direct measure of the product's C14 signature to the C14 signature of modern references.

The modern reference used was NIST-4990C with a C14 signature approximating CO2 in the air in AD 1950. ASTM D6866-16 cites a constant decline in this value of 0.5 pMC per year and provides requisite values to be used according to the year of measurement. The adjustment factor is termed “REF”. The consequence of bomb carbon is that the accuracy of the % bio-based carbon content will depend on how well REF relates to when the bio-based material in the product was last part of a respiring or metabolizing system. The most accurate results will be derived using bio-based material from short-lived material of very recent death such as corn stover, switch grass, sugar cane bagasse, coconut husks, flowers, bushes, branches, leaves, etc. Accuracy is reduced in materials made from wood contained within tree rings. ASTM D6866-16 cites to use average values of past carbon pMC for REF when values greater than 100 pMC are measured. Although analytical precision is typically 0.1 to 0.4 pMC, ASTM D6866-16 cites an uncertainty of +/−3% (absolute) on each % bio-based carbon result. The reported % bio-based carbon only relates to carbon source, not mass source.

The LDPE foam described in this invention, sample 1, was found to have 99% bio-based-carbon content based on the above-mentioned test. A petroleum-based LDPE foam, sample 2, was used as a control foam for comparison. Sample 2 had a 0% bio-based carbon content. In conclusion, it was found that sample 1 had 99% bio-based content and would be considered a renewable polyolefin foam and sample 2 would be a non-renewable polyolefin as it is petroleum-based and had no bio-based carbon content.

### Example 2: Method of Making a Renewable Foam

A renewable foam was made in an extrusion process. A renewable LDPE resin from Braskem was used. The renewable LDPE had a 96% C14 content, density of 0.923 g/cm3, melt flow rate of 2.0 at 190° C. and loading of 2.16 kg. It was made from sugarcane-based ethanol as feedstock to produce ethylene and then polymerized to produce LDPE. 50% talc masterbatch in LDPE carrier resin (Polyfil Corporation) was used to nucleate foam cells. The standard glycerol mono-stearate (GMS) Kemester 124 flake supplied by PMC Biogenix was used as an aging modifier for stabilizing the cells and isobutane gas was used as a blowing agent to expand the foam.

FIG. 1 shows the schematic diagram of the foam extrusion process. The resin, Braskem SLD 4004, and the nucleating agent were fed into a first hopper 1 and fed into a counter-rotating twin-screw extruder 5. The aging modifier was added to an extruder 5 in a second hopper at a second location 15. The blowing agent was added to the extruder 5 in a third hopper at a third location 20. An annular die 25 was used to extrude one inch (25.4 mm) thick sheets in the form rolls. When the foam expanded 10 in the circular form coming out of the annular die 25, it was slit at the bottom to make a flat sheet and the sheet was partially perforated for easy gas exchange with air and then it was cooled sufficiently close to room temperature by sending it through various size rollers before winding it onto a core to form large diameter rolls. These sheets were then heat laminated by a hot air lamination process to form 2″ (50.8 mm) thick planks and edges were trimmed to make 48 inches (1.2192 meter) in width. To compare properties, two standard “control” samples, control 1 and control 2, were produced by using the petroleum-based LDPE resin at standard operating conditions from production runs were used. They petroleum-based LDPE resin has a density of 0.918 g/cm³ and melt flow rate of 2.29 g/10 min and a melt flow ratio (21.6 kg/2.16 kg) of 50.5. The process and equipment used were the same and 1″ rolls were laminated similarly to produce 2″ thick planks before testing properties. Control 2 had a slight mint color green (color masterbatch was supplied by Techmer Polymer Modifiers with density of 1.32 g/cm³) to cover a broad range of products. Process conditions and properties for these foams can be seen in Table 2 below.

TABLE 2

| Description | Control 1 | Control 2 | Sample 1 |
|---|---|---|---|
| Resin used | Petroleum- | Petroleum- | Renewable |
| | based LDPE | based LDPE | LDPE |
| Formulation | | | |
| Resin rate, lbs/hr | 1300 | 1300 | 1300 |
| 50% Talc Masterbatch, lbs/hr | 5.50 | 5.25 | 3.75 |
| Glycerol monostearate, lbs/hr | 13.0 | 13.0 | 13.0 |
| Isobutane, lbs/hr (% solids) | 160.3 | 160.0 | 159.0 |
| | (12.16%) | (12.14%) | (12.07%) |
| Colorant, lb/hr | | 3.9 | |
| Extrusion Conditions | | | |
| Screw Speed, rpm | 21.8 | 21.7 | 21.8 |
| Melt Temperature, ° F. | 232.0 | 233.4 | 233.6 |
| Die pressure, psi | 548 | 546 | 568 |
| Extruded 1″ Roll properties | | | |
| Density, lb/ft³ | 1.40 | 1.40 | 1.38 |
| Thickness, inches | 1.05 | 1.064 | 1.07 |
| 2″ Laminated Plank | | | |
| Properties | | | |
| Density, lb/ft³ (after | 1.35 | 1.35 | 1.37 |
| lamination) | | | |
| Cell Count, MD/CMD | 19/18 | 18/18 | 18/21 |
| (Machine Direction/Cross- | | | |
| machine direction) | | | |
| 25% Compression strength, | 7.6 | 6.0 | 8.1 |
| psi (ASTM D3575) | | | |
| 50% Compression strength, | 17.8 | 15.4 | 17.2 |
| psi (ASTM D3575) | | | |
| % Bio-based carbon content | None | None | 99% |

As seen in Table 2, sample 1 exhibits 6% higher compression strength than control 1 and 35% higher compression strength than control 2 at 25% compression. Also, sample 1 has a cell count that is slightly finer in the cross-machine direction.

### Example 3: Drop Tests

Drop tests were performed to evaluate transmitted shock cushioning for sample 1. A Lansmont M65/81 shock machine was used for the drop tests. A test pack is prepared using a test box, a piece of sample 1 in the test box, and a static load placed inside the void of the piece of sample 1. Additional sample 1 foam is used to center the static load and is placed around the static load. Additional sample 1 foam is used as cushion placement to fill any remaining empty space in the test pack. The test pack is placed under a table, allowing for 1.5 inches of rebound space. An accelerometer is connected and a drop is performed at various heights. Drop tests were performed at 12 inches, 18 inches, 24 inches, 30 inches and 36 inches. Control 1 and control 2 shown in Table 2 were also tested under identical conditions for comparison.

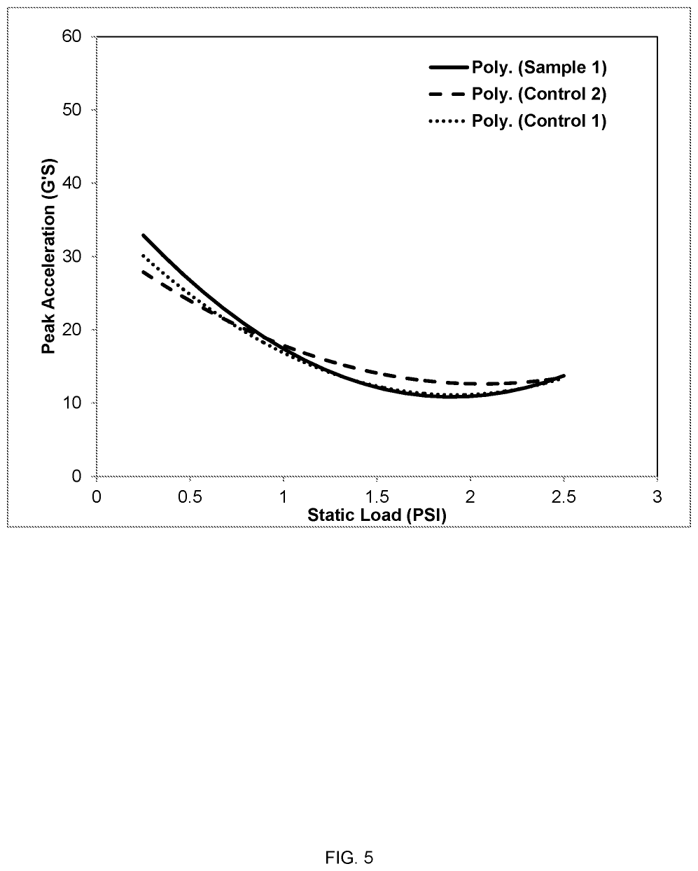

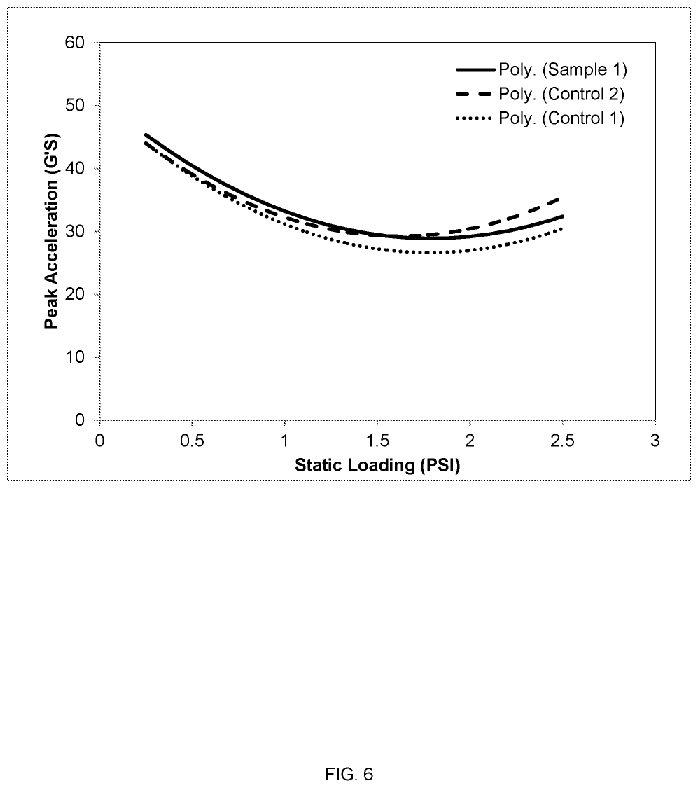

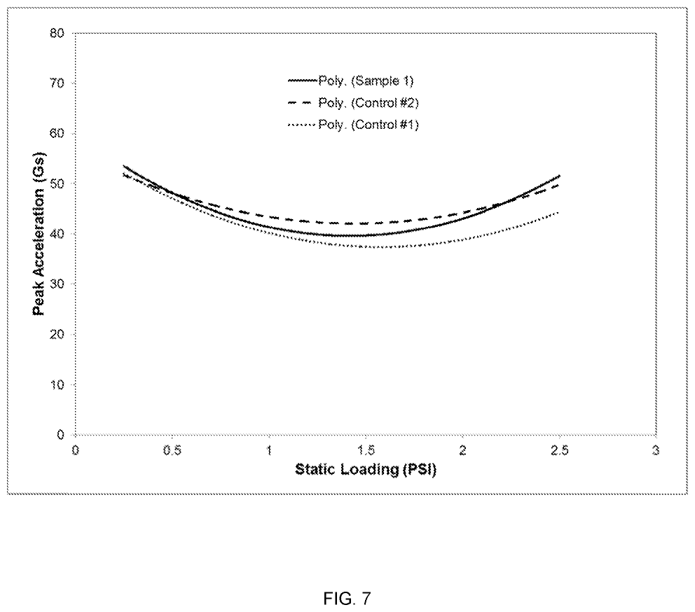

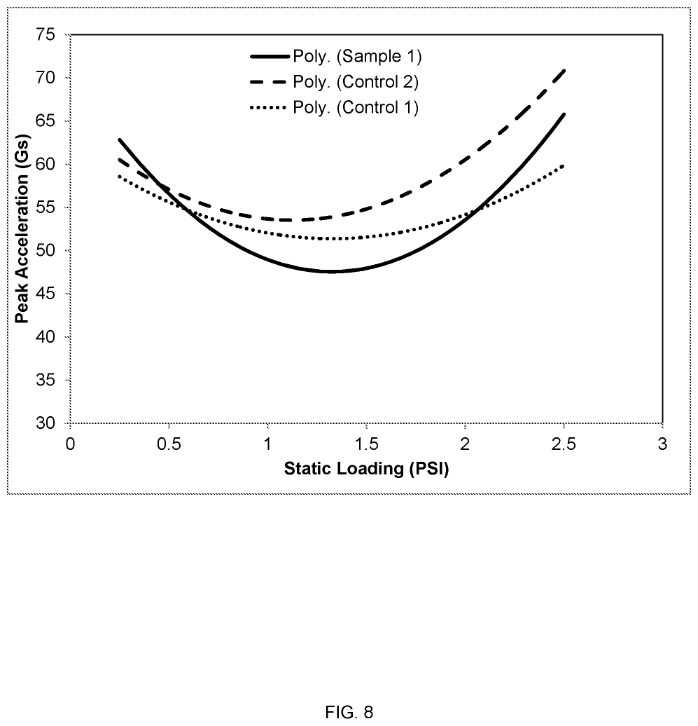

FIGS. 5-8 show the cushioning curves for the above foams at 12″, 24″ 30″, and 36″ drop heights, respectively. Sample 1, control 1 and control 2 each had 2-5 drops at each drop height. The different drop heights were to illustrate low, medium and high drop heights to relate to real life applications. As seen in FIG. 5, the cushioning performance is similar at 12″ for all samples. As seen in FIG. 6, For 24″ drop height, control 2 and sample 1 are similar, with control 1 appearing to give 1 or 2 lower G's cushioning, but all samples have overall similar cushioning curves. The 18″ produced similar results (not shown) as the 12″ and 24″ drop tests, no significant difference was seen in sample 1, control 1, or control 2. The 18″ drop test had only a small 1-2 G's difference when comparing sample 1, control 1 and control 2. As seen in FIG. 7, The 30″ drop tests produced mixed results (similar 1-2 G's up to 0.75 psi and 3-7 G's between 1.5-2.5 psi). Sample 1 shows slightly better performance than control 2 but less than control 1 foam. However, when the drop height has increased to 36″ (FIG. 8) which can be experienced in shipping operations, sample 1 surprisingly offers improved cushioning performance up to 4-6 G's between 0.6 to 2 psi when compared to control 1 and control 2. This improvement was shown consistently. This may be due to combination of molecular structure, cell structure and polymer chain entanglement characteristics producing much better shock absorption characteristics.

### Example 4: Foam Thickness Testing

Foam was extruded at various thicknesses and the foam properties and extrusion conditions were evaluated. Sample 2 as a 0.25 inch thick foam sheet and with a density of 2.27 lb/ft³ was extruded for testing. Sample 2 was extruded using the same counter-rotating twin screw extruder as described in Example 2. Table 3 gives the extrusion conditions and foam properties for sample 2.

TABLE 3

| | | Sample 2, |
|---|---|---|
| | Sample 2, Actual | wt % of |
| Ingredients | Weight, lbs/hr | solids |
| Solids: | | |
| SLD4004 LDPE | 600 | 98.36% |
| 50% Talc | 4 | 0.66% |
| Masterbatch | | |
| Glycerol | 6 | 0.98% |
| monostearate | | |
| Total (lbs/hr) | 610 | 100% |
| Gas: | | |
| Isobutane, lbs/hr (% | 72 (11.8%) | |
| of solids) | | |
| Extrusion | | |
| Conditions: | | |
| Screw speed, RPM | 11.6 | |
| Melt temperature, ° F. | 234.7 | |
| Die pressure, psi | 694 | |
| Foam Properties: | | |
| Density, lb/ft³ | 2.27 | |
| Thickness, inches | 0.241 | |
| Roll width, inches | 50.75 | |
| Cell count, MD/CMD | 22/22 | |

Table 4 below has the properties for sample 2. These property values are acceptable for commercial use and applications.

TABLE 4

| Properties | | Sample 2 |
|---|---|---|
| 0.25 inch thick Bio-Based PE Foam | | Test |
| ASTM D3575 | Units | Results |
| Section 8 - Dimensions - Thickness | Inches | 0.237 |
| Suffix W - Density | lbs/ft³ | 2.37 |
| Suffix B - Compression Deflection (Set) | Percentage | 25.4 |
| Suffix D - Compression Strength | lbs/ft³ | 5.22 |
| Cell Count - MD/CMD | no./linear | 18/21 |
| | inch | |
| Suffix L - Water Absorption | lbs/ft³ | 0.001 |
| Suffix S - Thermal Stability | Inches | <+/−5% |
| Suffix T - Tensile Strength - MD/CMD | psi | 71.5/40.7 |
| Suffix T -% Elongation - MD/CMD | % | 123.1/101.2 |
| Suffix G - Tear Resistance - MD | psi | 14.9/17.2 |

Sample 3 as a 0.5 inch thick foam sheet and with a density of 1.52 lb/ft³ was extruded for testing. Sample 3 was extruded using the same counter-rotating twin screw extruder as described in Example 2. Table 5 gives the extrusion conditions and foam properties for sample 3.

TABLE 5

| | | Sample 3, |
|---|---|---|
| | Sample 3, Actual | wt % of |
| Ingredients | Weight, lbs/hr | solids (rounded) |
| Solids: | | |
| SLD4004 LDPE | 600 | 98.5% |
| 50% Talc | 3.25 | 0.5% |
| Masterbatch | | |
| Glycerol | 6 | 1.0% |
| monostearate | | |
| Total (lbs/hr) | 609.25 | 100% |
| Gas: | | |
| Isobutane, lbs/hr (% | 72 (11.81%) | |
| solids) | | |
| Extrusion | | |
| Conditions: | | |
| Screw speed, RPM | 11.6 | |
| Melt temperature, ° F. | 234.2 | |
| Die pressure, psi | 512 | |
| Foam Properties: | | |
| Density, lb/ft³ | 1.52 | |
| Thickness, inches | 0.528 | |
| Roll width, inches | 49.75 | |
| Cell count, MD/CMD | 21/22 | |

Table 6 below has the properties for sample 3. These property values are acceptable for commercial use and applications.

TABLE 6

| 0.5 inch Sheet Bio-Based Foam Properties | | Sample 3 |
|---|---|---|
| ASTM D3575 | Units | Test Results |
| Dimensions - Thickness | Inches | 0.547 |
| Suffix W - Density | lbs/ft³ | 1.48 |
| Suffix B - Compression Deflection (Set) | Percentage | 11.60% |
| Suffix D - Compression Strength | lbs/ft³ | 10.2 |
| Cell Count - MD/CMD | no./linear | 18/17 |
| | inch | |
| Suffix L - Water Absorption | lbs/ft³ | 0.003 |
| Suffix S - Thermal Stability | Inches | <+/−5% |
| Suffix T - Tensile Strength - MD/CMD | psi | 34.7/25.2 |
| Suffix T - % Elongation - MD/CMD | Percentage | 124.9/118.6 |
| Suffix G - Tear Resistance - MD | psi | 7.31/10.92 |

In conclusion, this example demonstrates that good quality bio-based polyethylene foams (samples 2 and 3) can be made successfully at various thicknesses and densities.

### Example 5: Method of Making a Foam from a Blend of Polyolefins

A foam having a blend of a petroleum-based polyolefin and a renewable polyolefin (Sample 4) was prepared. This foam was referred to as a hybrid foam or a hybrid blend foam since it had both a renewable polyolefin and a non-renewable polyolefin. The polyolefins were a recycled petroleum-based LDPE and a renewable LDPE. The renewable LDPE resin from Braskem as mentioned in Example 2 was used. The renewable LDPE had a 96% C14 content, density of 0.923 g/cm3, melt flow rate of 2.0 at 190° C. and loading of 2.16 kg. It was made from sugarcane-based ethanol as feedstock to produce ethylene and then polymerized to produce LDPE.

25% renewable LDPE, 0.5% colorant polyolefin masterbatch, 74.5% recycled petroleum-based LDPE was added to the primary extruder of the tandem extrusion system. Tandem extrusion system had primary and secondary extruders. The primary extruder was used for adding ingredients and an isobutane blowing agent and then mixing to cool the molten mixture. The secondary extruder was used for melt cooling. Total resin rate was 2455 lbs/hr and isobutane rate was at 280 lbs/hr and the aging modifier, glycerol mono-stearate flake (Kemester 124) rate was at 23.5 lbs/hr. A flat die was used to extrude planks that were 1.5 inches thick and 48 inches in width. The resin ratio of renewable LDPE to non-renewable petroleum based recycled LDPE was 25/75 approximately. The resulted foam was cooled in the conveyor and needle punched to exchange gas with air to cure the foam. Foam properties for Sample 4 were tested as per ASTM test standards. Results for Sample 4 are shown in the attached table below. These properties are excellent for protective packaging applications.

TABLE 7

| | Sample 4 |
|---|---|
| Properties | Values |
| Density, lb./cu ft., ASTM D3575, Suffix W | 1.52 |
| Cell Count, cells/inch, MD/CMD | 20/18 |
| Compression Strength, 25%, ASTM D3575 Suffix D | 8 |
| Compression Strength, 50%, ASTM D3575, Suffix D | 16.1 |
| Creep at 1.75 psi, 168 hours, ASTM D3575, Suffix BB | 6.4% |
| Compression set (%), ASTM D3575, Suffix B | 21.9% |
| Tensile Strength, psi, ASTM D3575, Suffix T, MD/CMD | 37.4/16 |
| Elongation (%), ASTM D3575, Suffix T, MD/CMD | 75/77 |
| Tear resistance, lb./in., ASTM D3575, Suffix G, | 5.9/10.6 |
| MD/CMD | |

1. A method of making a foam, the method comprising:
creating a blend of a polyolefin made from sugarcane ethanol with a minimum biocontent of 94% as determined by ASTM D6866-16, less than 3% of a nucleating agent, and 0.2% to 2% of an aging modifier;
mixing a physical blowing agent with the blend to form a mixture; and
expanding the mixture to make the foam;
wherein the foam comprises 10% to 99% biocontent as determined by ASTM D6866-16 and has a density of 1 to 12 pounds per cubic foot.

2. The method of claim 1, wherein the polyolefin is a low density polyethylene.

3. The method of claim 1, wherein the blend comprises 96% to 99% of the polyolefin.

4. The method of claim 1, wherein the blend further comprises a petroleum-based polyolefin.

5. The method of claim 4, wherein the petroleum-based polyolefin comprises at least one member selected from the group consisting of virgin petroleum-based polyolefin and recycled petroleum-based polyolefin.

6. The method of claim 1, wherein the nucleating agent comprises at least one member selected from the group consisting of silica, talc, zinc oxide, zirconium oxide, clay, mica, titanium oxide, calcium silicate, metallic salts of fatty acids such as zinc stearate, self-nucleating agents such as carbon dioxide, nitrogen and other gases, and chemical foaming agents.

7. The method of claim 1, wherein the nucleating agent is a talc mixture.

8. The method of claim 1, wherein the nucleating agent is a chemical foaming agent.

9. The method of claim 1, wherein the aging modifier comprises at least one member selected from the group consisting of a fatty acid amide, a fatty acid ester, glycerol monostearate, and a hydroxyl amide.

10. The method of claim 1, wherein the aging modifier is glycerol monostearate.

11. The method of claim 1, wherein the physical blowing agent comprises at least one member selected from the group consisting of air, argon, boron tetrafluoride, boron trichloride, normal 20-butane, carbon dioxide, helium, hexafluoride, hydrocarbons such as ethane, hexane, isobutane, nitrogen, nitrogen tetrafluoride, nitrous oxide, pentane, propane, silicon tetrafluoride, sulfur hexafluoride, water, and xenon.

12. The method of claim 1, wherein the physical blowing agent is isobutane.

13. (canceled)

14. The method of claim 1 wherein the blend further comprises an additive comprising at least one member selected from the group consisting of pigments, colorants, fillers, stability control agents, antioxidants, flame retardants, stabilizers, fragrances, odor masking agents, antistatic agents, lubricants, foaming aids, coloring agents, and deterioration inhibitors.

15. (canceled)

16. A foam comprising:
a polyolefin made from sugarcane ethanol with a minimum biocontent of 94% as determined by ASTM D6866-16;
less than 3% of a nucleating agent; and
0.2% to 2% of an aging modifier;
wherein the foam comprises 10% to 99% biocontent as determined by ASTM D6866-16 and has a density of 1 to 12 pounds per cubic foot.

17. The foam of claim 16, wherein the thickness of the foam is 0.5 mm to 100 mm.

18. (canceled)

19. The foam of claim 16, wherein the foam is a homogeneous plank.

20. (canceled)

21. (canceled)

22. (canceled)

23. The foam of claim 16, further comprising a petroleum-based polyolefin.

24. The foam of claim 16, further comprising less than 0.5% isobutane.

25. A foam laminate comprising:
a first foam layer, and
a second foam layer adhered to the first foam layer;
wherein the first foam layer and the second foam layer comprises 10% to 99% biocontent as determined by ASTM D6866-16 and has a density of 1 to 12 pounds per cubic foot.

26. (canceled)

27. The foam laminate of claim 25, wherein the thickness of the foam laminate is 40 mm to 200 mm.

28. (canceled)
